(19) United States
(12) Patent Application Publication
(10) Pub. No.: US 2010/0314853 A1
(43) Pub. Date: Dec. 16, 2010

(54) Mallory trailer hitch

(76) Inventor: John William Mallory, St. Petersburg, FL (US)

Correspondence Address: John William Mallory, PO Box 49171, St Petersburg, FL, 33743, US

(21) Appl. No.: 12/456,039

(22) Filed: Jun. 10, 2009

(51) Int. Cl. B60D 1/36

(52) U.S. Cl. 280/477

(57) ABSTRACT

The Mallory Trailer Hitch, eliminates the embarrassing need to align the tow vehicle repetitively. Giving the purchaser the ease of move ability in securing the Trailer Ball in a single attempt. The Mallory Trailer Hitch is self Locking insuring a safe and secure hook up of the tow vehicle.

### CROSS-REFERENCE TO RELATED APPLICATIONS

### STATEMENT REGARDING FEDERALLY SPONSORED RESEARCH OR DEVELOPMENT

“NOT APPLICABLE”

### REFERENCE TO SEQUENCE LISTING, A TABLE, OR A COMPUTER PROGRAM LISTING COMPACT DISK APPENDIX

“NOT APPLICABLE”

### BACKGROUND OF THE INVENTION

This invention pertains to the Field of Couplings, db. Automotive or farm Equipment

Prior Art, have touched lightly on the aligning mechanical abilities of this area. As well as the securing devices used in the same application of art. My resurrect has shown that each Prior Art on the market, for purchase by consumers, gives little attention to the ease of application of the Art.

### BRIEF SUMMARY OF THE INVENTION

The Mallory Hitch, will eliminate the need for repetitive alignments of the towing vehicle. It will allow the purchaser, to back to the general location, insuring the ability to hook up.

The Mallory Hitch, will upon hookup, and initial vehicle movement self lock into place. Further eliminating potentially forgotten steps to safety.

The heavy duty design, insures the ability to safely handle any hauling needs. From single through to triple axle trailers, as well as the ability to fix most popular reliever sizes, eliminating the need to purchase a new receiver

### BRIEF DESCRIPTION OF THE SEVERAL VIEWS OF THE DRAWING

FIG. 1A Top View—Mallory Hitch shown completely straight and locked in place, ready to tow.

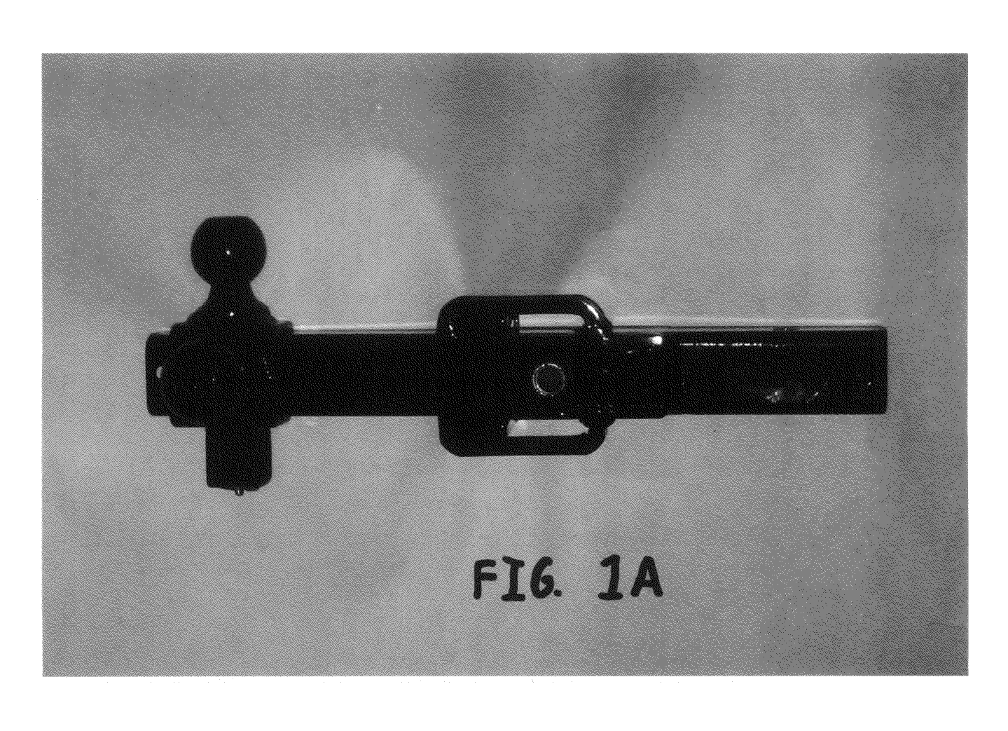

FIG. 1B Top bent view of Mallory Hitch shown to depict a possible angle hook up, locking, device are in the upward position, allowing for vehicle to straighten and lock Hitch into tow-able state,

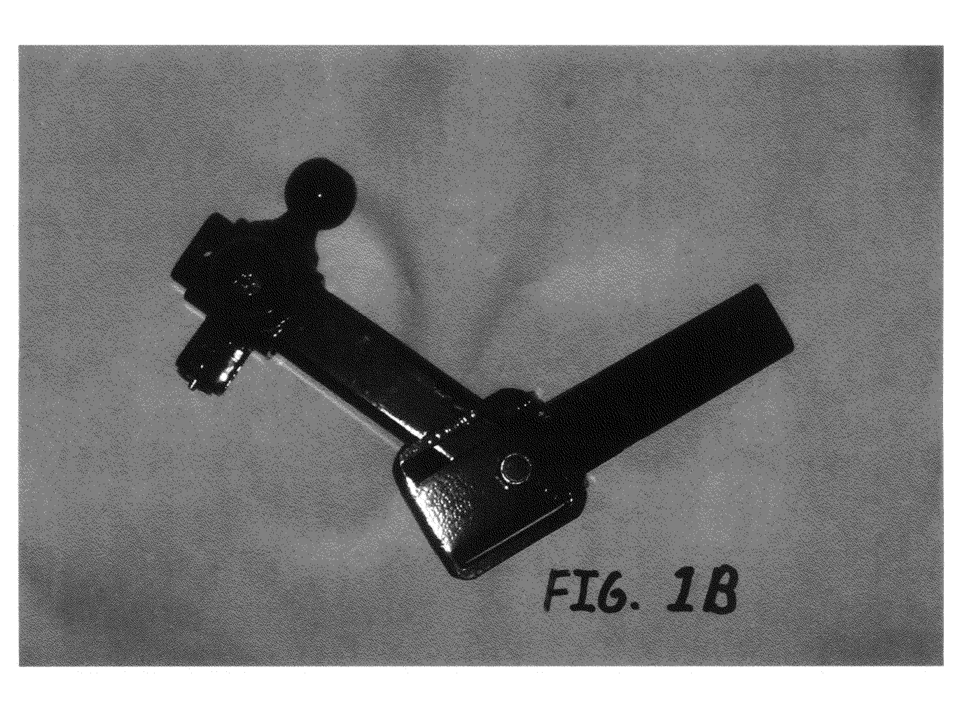

FIG. 1C Mallory Hitch shown from side in a locked position.

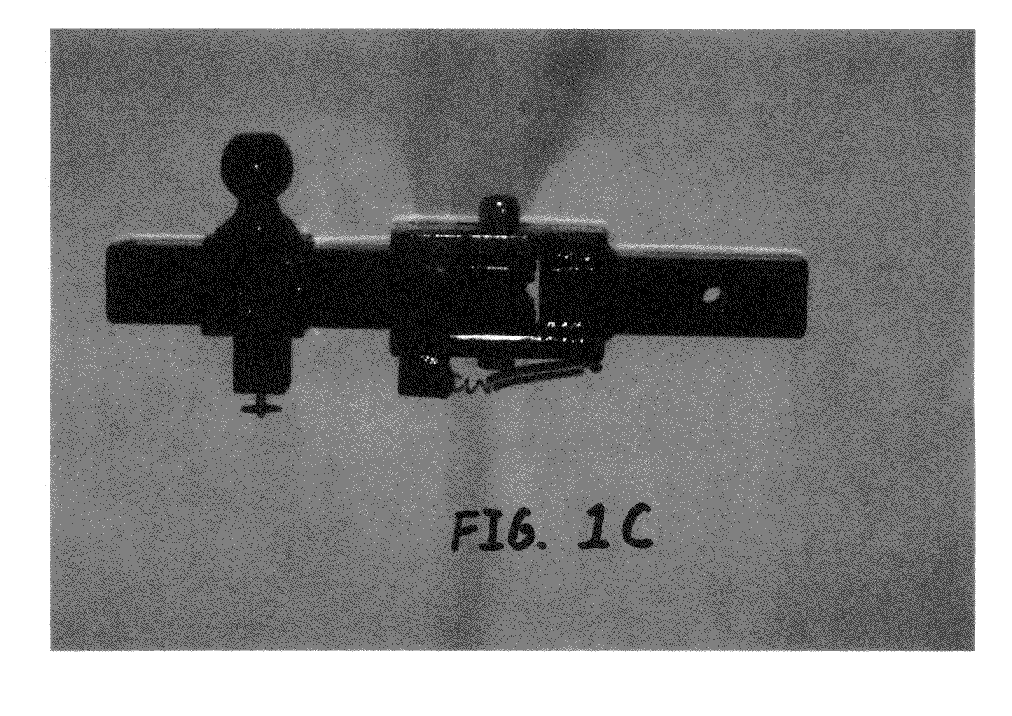

FIG. 1D Mallory Hitch, showing the sliding, self locking trailer ball device in a side view, allowing to slide and lock into a straight position.

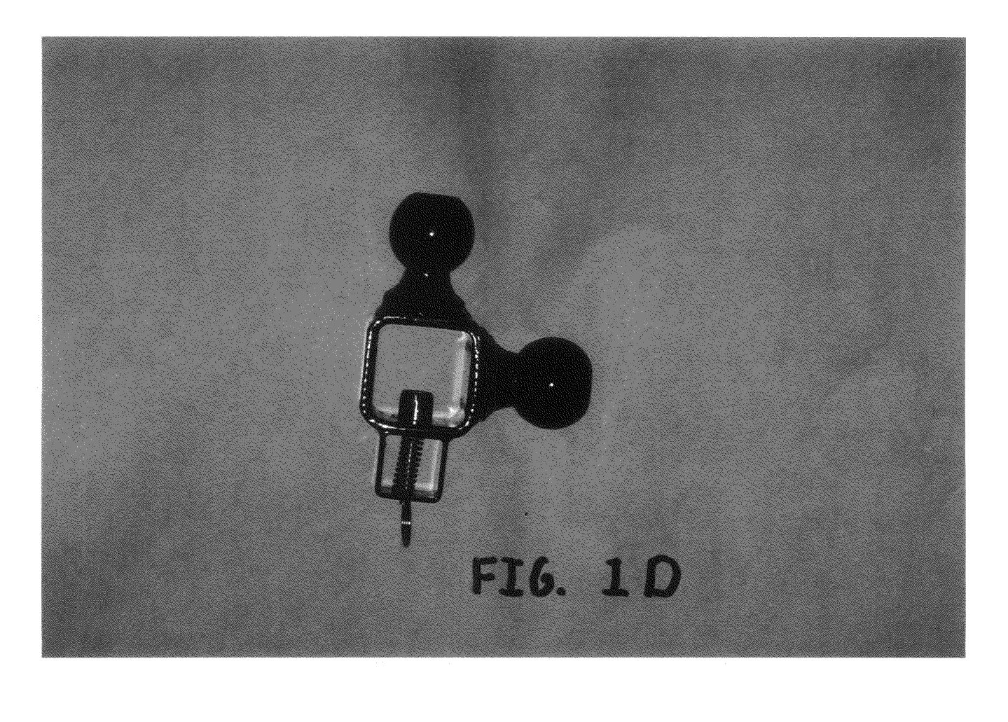

### DETAILED DESCRIPTION OF THE INVENTION

The Mallory Trailer Hitch is designed to have multiple pivoting and rotating points. Which enable it to be placed in a multitude of directions, unlike the Prior art that has a up or down limited movement, or an even more limited side to side variance.

The Mallory Hitch, unlike other Prior Art, is designed to have a self latching or locking device, once the trailer is pulled into a tow able position

Drawings are labeled to depict the view, the numerical sequence depicts the parts submitted in the art.

1. Square tubing, receiver end.

2. Locking Springs.

3. 3A and 3B are both flat plates for the connecting of pivoting points.

4. Square tubing receiving end for sliding ball mechanism.

5. 5A and 5B depict the pivoting points and pivoting rod.

6. 6A and 6B depict the spring loading latching device.

7. 7A depicts the through holes for sliding locking ball mechanism pin.

8. Pivoting rod for locking arm.

9. Square tubing for sliding ball mechanism.

10. View depicts locking pin mechanism.

11. Multiple ball sizes.

12. Locking arm channels.

1. What I claim as my invention is the Mallory Trailer Hitch, a simple adjustable an alienable self locking, heavy duty trailer hitch.

2. The Mallory Trailer Hitch can be transferred easily from one tow vehicles, to another, with out the purchase of any additional mounting requirements, a simple Manufactured tow receiver is required.

3. the Mallory Trailer Hitch, is adaptable to accommodate a number of existing hitch balls.
